(19) United States
(12) Patent Application Publication
(10) Pub. No.: US 2015/0156033 A1
(43) Pub. Date: Jun. 4, 2015

(54) ACTIVE BYPASS SYSTEM FOR RING NETWORKS

(71) Applicant: GE Oil & Gas UK Limited, Nailsea (GB)

(72) Inventor: Matthew Edmund STONE, Clutton (GB)

(21) Appl. No.: 14/553,418

(22) Filed: Nov. 25, 2014

(30) Foreign Application Priority Data
Nov. 29, 2013 (GB) 1321079.4

(51) Int. Cl. H04L 12/437; H04L 12/26; E21B 47/12; H04L 12/24

(52) U.S. Cl. CPC H04L 12/437; H04L 41/0668; H04L 43/0817; E21B 47/12

(57) ABSTRACT

An active bypass system including an active bypass module having a first receiver connected to a first transmitter; and a slave node having a second receiver, a second transmitter, and a process node connected therebetween. During normal operation, data received by the first receiver is passed to the second receiver, and then passed to the process node for processing, after which a response is passed from the process node to the second transmitter, and then passed to the first transmitter. In the event of a failure of the slave node, data is received by the first receiver and then passed to the first transmitter, thereby bypassing the slave node.

### BACKGROUND OF THE INVENTION

Embodiments of the invention relate to an active bypass system, a method for transmitting data, and a ring network, for example in an underwater, e.g. subsea, hydrocarbon well facility.

Existing self-healing technologies take advantage of two rings to create a loop-back at the adjacent nodes when a failure is encountered. A prior art ring network of this type is shown in FIG. 1.

In normal operation, data is sent from the master M to the slave nodes B1, B2, and B3 using a primary (outer) ring and a secondary (inner) ring. If a slave node fails, the slave nodes upstream and downstream of the failed node reroute data automatically, and data continues to circulate through the network. In FIG. 1, the dotted lines show how the data would be rerouted in the event of a failure of slave node B2.

However, in subsea systems, when copper is at a premium due to the offsets involved, this can be a very expensive solution.

It is an aim of the present invention to provide a self-healing architecture which only requires a single ring (i.e. half the copper). In accordance with embodiments of the invention, this is achieved by using a single ring network having a number of active bypass system modules, each having a repeater therein. Each repeater is connected to a respective slave node. During normal operation the active bypass system module passes the ring message into the slave node, and then forwards the slave node's response to the next active bypass system module.

If a slave fails, the active bypass system module forwards the receive message directly onto the next active bypass system module, effectively “hopping” the failed slave. This system is designed to recover from the failure of a slave, not a break in the ring itself, as this type of failure would indicate a severe mechanical failure from which subsea ring technologies would not be able to recover from (for example, a break in the umbilical, failure of a connector, severance of a communication/power cable, etc.). This system would also allow for the decommissioning/maintenance of individual slaves without the need to take the entire field offline.

### BRIEF SUMMARY OF THE INVENTION

According to an aspect of the present invention, there is provided an active bypass system comprising: an active bypass module comprising a first receiver connected to a first transmitter; and a slave node comprising a second receiver, a second transmitter, and a process node connected therebetween; the first receiver being connected to the second receiver and the second transmitter being connected to the first transmitter. In normal operation, data received by the first receiver is passed to the second receiver, and then passed to the process node for processing, after which a response is passed from the process node to the second transmitter, and then passed to the first transmitter. In the event of a failure of the slave node, data received by the first receiver is passed to the first transmitter, thereby bypassing the slave node.

According to a second aspect of the invention, there is provided a method of transmitting data. The method comprises supplying data to an active bypass system thatcomprises: an active bypass module comprising a first receiver connected to a first transmitter; and a slave node comprising a second receiver, a second transmitter, and a process node connected therebetween; the first receiver being connected to the second receiver and the second transmitter being connected to the first transmitter. The method further comprises: in normal operation, passing data received by the first receiver to the second receiver, and then passing the data to the process node for processing, passing a response from the process node to the second transmitter, and then passing the response to the first transmitter; and in the event of a failure of the slave node, passing data received by the first receiver to the first transmitter, thereby bypassing the slave node.

The active bypass module may comprise a repeater connected intermediate the first receiver and the first transmitter. The repeater may comprise a watchdog which monitors the functioning of the process node. The watchdog may activate the repeater when it detects that the process node is not functioning. The watchdog may have a timer which is reset by a signal from the process node, the watchdog activating the repeater when the countdown elapses. In normal operation data received by the first receiver may be passed to both the second receiver and the repeater.

The system may be used in a control system for an underwater hydrocarbon well facility.

A ring network comprising a plurality of the active bypass systems is also claimed.

According to a third aspect of the invention, there is provided a ring network comprising: a plurality of active bypass modules connected to form a loop, wherein each active bypass module is connected to a respective slave node. In normal operation, data received by an active bypass module is passed to its respective slave node for processing, a response is passed back to said active bypass module, and said response is then passed the next active bypass module in the loop. In the event of a failure of a slave node, the active bypass module connected to said slave node detects that said slave node has failed, and passes received data directly to the next active bypass module in the loop.

The plurality of active bypass modules may be connected by a single copper ring.

The ring network may be used in a control system for an underwater hydrocarbon well facility.

### BRIEF DESCRIPTION OF THE DRAWINGS

Additional features, possibilities of use, and advantages of the invention can be inferred from the description of the embodiments of the invention hereinafter. In doing so, the object of the invention is represented by each of the described or illustrated examples, individually or in any combination, and independently of their summarization or their citation or illustration in the description, or in the figures. In the drawings:

FIG. 1 is a schematic diagram of a prior art self-healing ring topology;

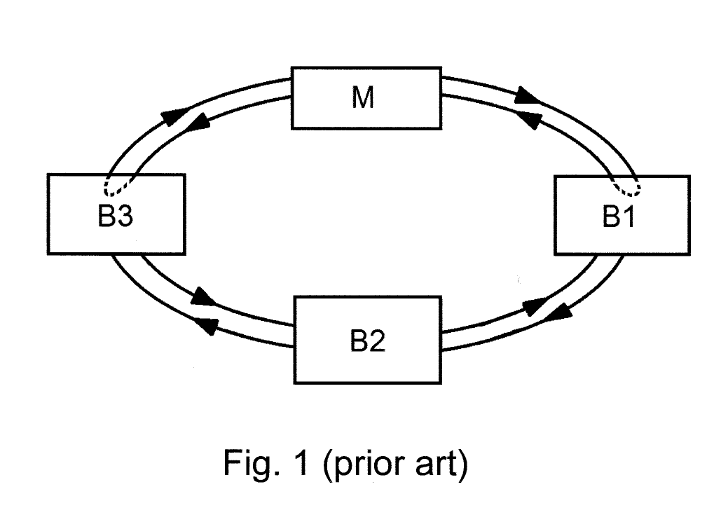

FIG. 2 is a schematic diagram of a ring network according to an embodiment of the invention; and

FIG. 3 is a schematic view of an active bypass system according to an embodiment of the invention.

### DETAILED DESCRIPTION OF THE INVENTION

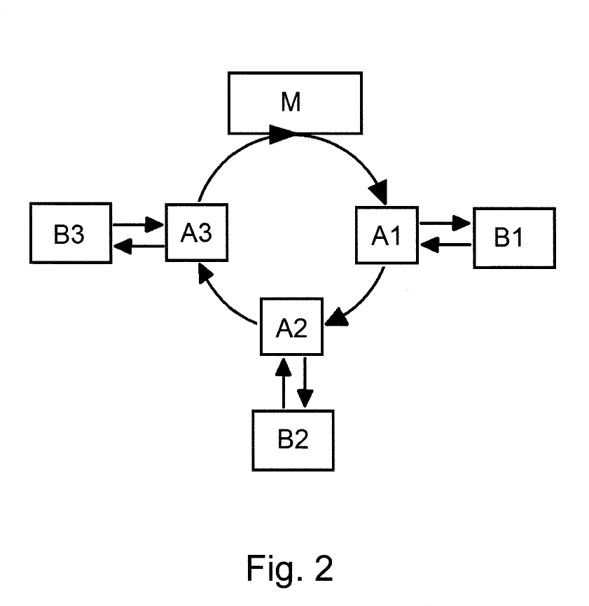

FIG. 2 shows a schematic diagram of a ring network according to an embodiment of the invention. A loop is formed between a master M and three active bypass modules A1, A2, and A3, which are respectively connected to slave nodes B1, B2, and B3.

In this network topology all of the “active circuitry”—i.e. most likely to fail components—have been removed from the active bypass modules A1, A2, and A3 that form part of the ring and placed into the lower level modules, slave nodes B1, B2, and B3. This makes it feasible to have only a single line of copper running between the active bypass modules, as the active bypass modules are a fully-stressed solution designed with very simple, non-active and high reliability components (e.g. components built to a military grade specification) to have the same reliability as the cable and connectors around it. In this way, the failure point of the system, on a component failure level, has been shifted to the slave nodes B1, B2, and B3. Mechanical failures, i.e. physical breaks in cables/connectors, at the ring level would knock out the system in an unrecoverable manner.

In normal operation, data is fed from the master M to the first active bypass module A1 and passed to the first slave node B1 for processing, after which a response is passed back to the first active bypass module to be passed on to the next active bypass module in the loop. This process is repeated at active bypass modules A2 and A3, after which a response is passed from active bypass module A3 back to the master M.

In the event of a failure of a slave node, e.g. slave node B2, the active bypass module connected to that slave node, e.g. active bypass module A2, will detect that the slave node is not functional, and will pass the received data on to the next active bypass module in the loop automatically. This network provides a self-healing topology which can still function following the failure of a slave node, yet only requires a single ring.

Although three active bypass systems and slave nodes are shown in FIG. 2, any number could be used in practice. The connection between the master and the active bypass modules could comprise a single ring of copper.

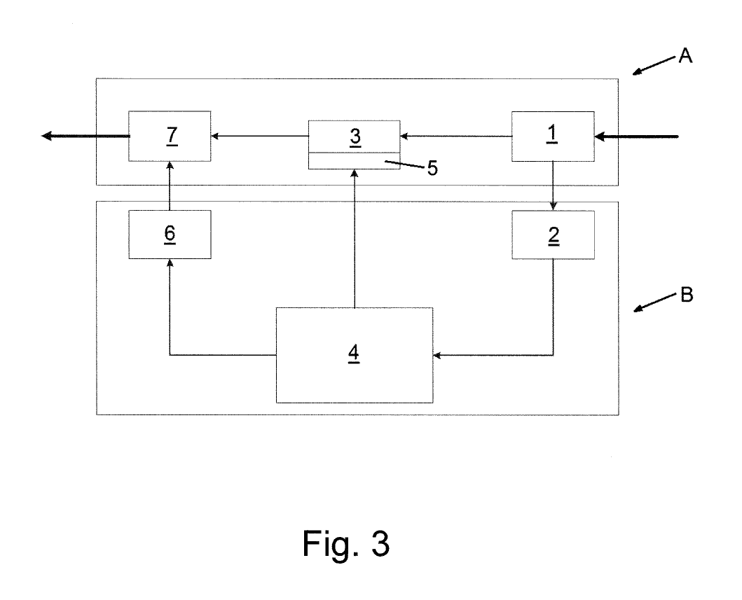

FIG. 3 shows a schematic view of an active bypass system as used in the system of FIG. 2, including an active bypass module A connected to a slave node B.

The active bypass module A comprises a first receiver 1 connected to a repeater module 3, which is in turn connected to a first transmitter 7. The repeater module 3 comprises a watchdog 5.

The slave node B comprises a second receiver 2 connected to a process node 4, which is in turn connected to a second transmitter 6.

In normal operations of the slave node B (i.e. when there are no faults with the system), the active bypass system module A will receive data into a first receiver 1, typically from the mesh/ring network. The first receiver 1 has a buffer which may pass any data received to two separate systems: a second receiver 2 of the slave node B and a repeater module 3.

In normal (i.e. fault-free) operation, data received into the second receiver 2 is passed into the process node 4 of the slave node B, which performs the slave node's primary processing functions.

The watchdog 5 contains a countdown timer which independently counts down to zero. When it reaches zero it triggers the activation circuitry of the repeater module 3. In normal operation, the process node 4 resets the watchdog countdown timer every time it successfully completes an operation, verifying that it is still functional. In this way, the repeater module 3 remains off for the duration of the data reception at second receiver 2, effectively discarding any data passed to the repeater module 3 from first receiver 1.

Once all data is received, the process node 4 of the slave node B processes the ring message as normal and passes its response to a second transmitter 6, which is directly connected to a first transmitter 7 of the active bypass system module A, and out to the next node in the ring network, or to the master if the node is the last in the ring (e.g. B3 as shown in FIG. 2).

In the case of a slave node failure, the data from the first receiver 1 passes directly to the repeater module 3. As the countdown timer of the watchdog 5 has not been reset by a signal from a functioning process node, the timer counts down to zero (i.e. the countdown elapses) and the watchdog 5 activates the repeater module 3, which forwards the signal to the first transmitter 7 and on to the next node (or master if the node is the last in the ring). The failed slave node B is thereby bypassed to allow the ring network to continue communicating.

Although FIG. 3 shows the countdown timer of the watchdog 5 being reset by the process node 4, in practice the receiver, processor and transmitter functions of the slave node B will have a single monitoring point on the slave node B. In this way, the watchdog 5 will not be reset if any of the elements of the process node B fail, i.e. the second receiver 2, the process node 4 or the second transmitter 6.

The design of the slave node modem board would be such that the watchdog 5 fundamentally monitors whether the slave node B is responding to requests through, for example, the use of a monitoring line on the integrated circuit, or through low level transmit line monitoring.

The active bypass system of embodiments of the present invention are designed to allow the automatic healing of remote mesh/ring networks without user intervention, allowing the system to complete a link back to the master receiver in the case of a malfunctioning node. The system works by introducing a layer between the network node and the rest of the network.

Embodiments of the invention allow for a ring network to continue to operate even if only a single slave is still functional on the system: a failure localised to individual slaves does not impact the operation of the field as a whole. This system would also allow for individual nodes to be taken offline (for example, for rework, etc.) whilst the rest of the field remained active. As a topology, it requires less copper than running star topology networks to each slave, and also does not have the bottleneck of a star hub: each slave can be daisy chained back to the master node without the fear of a single link in the chain (aside from physical breaks) bringing down the field.

Short offset fields can be made significantly more cost effective (no need for central communications distribution). Where ring network topology is necessitated, the entire system can be made more reliable. Ring network topology allows the use of newer point-to-point communication technologies, for example DSL. An extra node can be installed relatively simply, without the restriction of limited numbers of interfaces on star topologies.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. An active bypass system comprising:
an active bypass module comprising a first receiver connected to a first transmitter; and
a slave node comprising a second receiver, a second transmitter, and a process node connected therebetween, wherein the first receiver is connected to the second receiver and the second transmitter is connected to the first transmitter,
wherein:
in normal operation, data received by the first receiver is passed to the second receiver, and then passed to the process node for processing, after which a response is passed from the process node to the second transmitter, and then passed to the first transmitter, and
in the event of a failure of the slave node, data received by the first receiver is passed to the first transmitter, thereby bypassing the slave node.

2. The system according to claim 1, wherein the active bypass module further comprises a repeater connected intermediate the first receiver and the first transmitter.

3. The system according to claim 2, wherein the repeater comprises a watchdog which monitors the functioning of the process node.

4. The system according to claim 3, wherein the watchdog activates the repeater when it detects that the process node is not functioning.

5. The system according to claim 3, wherein the watchdog has a countdown timer which is reset by a signal from the process node, the watchdog activating the repeater when the countdown elapses.

6. The system according to claim 2, wherein in normal operation data received by the first receiver is passed to both the second receiver and the repeater.

7. The system according to claim 1, wherein the active bypass system is used in a control system for an underwater hydrocarbon well facility.

8. A method of transmitting data, the method comprising:
supplying data to an active bypass system comprising an active bypass module comprising a first receiver connected to a first transmitter; and a slave node comprising a second receiver, a second transmitter, and a process node connected therebetween, wherein the first receiver is connected to the second receiver and the second transmitter is connected to the first transmitter;
wherein:
in normal operation, passing data received by the first receiver to the second receiver, and then passing the data to the process node for processing, passing a response from the process node to the second transmitter, and then passing the response to the first transmitter, and
in the event of a failure of the slave node, passing data received by the first receiver to the first transmitter, thereby bypassing the slave node.

9. The method according to claim 8, wherein the active bypass module further comprises a repeater connected intermediate the first receiver and the first transmitter.

10. The method according to claim 9, wherein the repeater comprises a watchdog which monitors the functioning of the process node.

11. The method according to claim 10, wherein the watchdog activates the repeater when it detects that the process node is not functioning.

12. The method according to claim 10, wherein the watchdog has a timer which is reset by a signal from the process node, the watchdog activating the repeater when the countdown elapses.

13. The method according to claim 8, wherein in normal operation data received by the first receiver is passed to both the second receiver and the repeater.

14. The method according to claim 8, wherein the method of transmitting data is performed in a control system for an underwater hydrocarbon well facility.

15. A ring network comprising:
a plurality of active bypass modules connected to form a loop, wherein each active bypass module is connected to a respective slave node,
wherein:
in normal operation, data received by an active bypass module is passed to its respective slave node for processing, a response is passed back to said active bypass module, and said response is then passed the next active bypass module in the loop, and
in the event of a failure of a slave node, the active bypass module connected to said slave node detects that said slave node has failed, and passes received data directly to the next active bypass module in the loop.

16. The ring network according to claim 15, wherein the plurality of active bypass modules are connected by a single copper ring.

17. The ring network according to claim 15, wherein the ring network is used in a control system for an underwater hydrocarbon well facility.
